(19) United States
(12) Patent Application Publication
(10) Pub. No.: US 2026/0312338 A1
(43) Pub. Date: Oct. 8, 2026

(54) TERMINAL POSITION ASSURANCE FOR ELECTRICAL CONNECTOR

(71) Applicant: Aptiv Technologies AG, Schaffhausen (CH)

(72) Inventors: Andreas URBANIAK, Münster (DE); Uvaraj GANESAN, Tamil Nadu (IN); Rajan KUMARESH, Tamil Nadu (IN)

(21) Appl. No.: 19/537,695

(22) Filed: Feb. 12, 2026

(30) Foreign Application Priority Data
Apr. 4, 2025 (EP) 25168560.8

(51) Int. Cl. H01R 13/642; H01R 13/422; H01R 13/436; H01R 13/46; H01R 13/506

(52) U.S. Cl. CPC H01R 13/642; H01R 13/4223; H01R 13/4361; H01R 13/4362; H01R 13/4364; H01R 13/4365; H01R 13/465; H01R 13/506

(57) ABSTRACT

A terminal position assurance (TPA) device for an electrical connector includes an assembly body attachable to the electrical connector housing and a locking body with at least one locking member corresponding to a terminal receiving cavity. The locking body is connected to the assembly body via a hinge member, which has two positions defining open and closed states of the TPA device. In the closed state, the locking member engages a terminal within the terminal receiving cavity, ensuring secure positioning. The TPA device provides a reliable mechanism for verifying terminal placement within the electrical connector.

### CROSS-REFERENCE TO RELATED APPLICATION

This application claims the benefit of and priority to European Application No. 25168560.8 filed with the European Patent Office on Apr. 4, 2025, the contents of which are incorporated by reference herein.

### TECHNICAL FIELD

The present disclosure relates to a terminal position assurance (TPA) device for an electrical connector. The present disclosure also relates to a kit including an electrical connector and at least one separate TPA device, and to an assembly including an electrical connector and at least one TPA device.

### BACKGROUND

In the field of electrical connectors, it is common to use mechanisms called terminal position assurance (TPA) devices that ensure that electrical terminals are correctly and securely positioned within a connector housing. A TPA device is critical for maintaining reliable electrical connections, especially in applications where connectors are subjected to vibration or other mechanical stress. Known electrical connectors typically involve TPA devices that are either integral parts of the connector housing or are inseparably attached to the housing. A TPA device has a first open position and can be closed by moving it to a second closed position. In the closed position, the TPA device typically reaches into terminal receiving cavities of the connector housing to engage with the electrical terminals therein. This design ensures that the electrical terminals remain securely seated within their respective cavities, thereby preventing disconnection or electrical failure.

Despite the widespread use of TPA devices in electrical connectors, known TPA devices lack flexibility. Typically, a connector housing comes with one specific type of TPA device. This lack of flexibility can be problematic in various applications, particularly when connectors need to be adapted to different configurations or when maintenance or repair requires a new TPA device. Additionally, the fixed nature of these TPA devices can complicate the manufacturing process of the connector, as it necessitates precise alignment and attachment during assembly, potentially increasing production costs and time.

Furthermore, the increasing demand for connectors capable of handling higher voltages introduces additional challenges for TPA devices. Higher voltages necessitate the introduction

of dielectric materials between the terminals within the housing to ensure insulation and ensure safe operation. However, having a connector housing with a fixed TPA device restricts the connector to certain voltage ranges, limiting its versatility and applicability in various high-voltage scenarios. This restriction can be particularly limiting in industries such as automotive, aerospace, and industrial equipment, where connectors must meet stringent electrical and mechanical requirements.

FIGS. 1A and 1B show a TPA device known in the prior art. The TPA device is depicted in two views, one attached to an electrical connector housing 20 and the other as a standalone component. The electrical connector housing 20 is part of an electrical connector 2, which includes multiple terminal receiving cavities 22. These cavities are designed to receive and secure electrical contact terminals.

This TPA device includes an assembly body 10 and a locking body 30, which are arranged in a U-shaped configuration. The assembly body 10 is configured to attach to the electrical connector housing 20. The locking body 30 features a plurality of locking members 32. These locking members 32 are arranged in a manner that corresponds to the terminal receiving cavities 22 within the electrical connector housing 20. The working principle of such TPA devices is generally known to the skilled person. Accordingly, a detailed explanation is omitted.

FIG. 2 shows an integrated TPA device known in the prior art. The electrical connector 2 is depicted with an electrical connector housing 20. The housing 20 includes terminal receiving cavities 22, which are designed to accommodate electrical terminals. The TPA device is integrated within the housing 20.

The housing 20 is shown with a pair of flexible locking arms 26 that form the TPA device and extend outwardly from the sides of the housing. These locking arms 26 are designed to engage with corresponding features on the connector housing 20 to ensure a secure connection. The locking arms 26 are typically made from a resilient material that allows them to flex and snap into place when the connectors are mated. The locking arms 26 are flexibly connected to the connector housing 20 by means of a connection portion 28. The working principle of such integrated TPA devices is generally known to the skilled person. Accordingly, a detailed explanation is omitted.

### SUMMARY

It is an object of this disclosure to provide a terminal position assurance device that overcomes one or more of the disadvantages of known TPA devices.

A terminal position assurance (TPA) device for an electrical connector is disclosed herein. The TPA device includes an assembly body that is configured to be attached to an electrical connector housing and a locking body having at least one locking member configured to correspond to a terminal receiving cavity of the electrical connector housing. The locking body is connected to the assembly body by a hinge member movable between a first position defining an open state of the TPA device and a second position defining a closed state of the TPA device. In the open state, the locking member is not operable to engage a terminal within the terminal receiving cavity. In the closed state, the locking member is operable to engage the terminal to secure the terminal within the cavity.

In some embodiments, the locking body includes a plurality of locking members. The locking members may be configured as locking teeth or as a locking blade. In some embodiments, the assembly body includes a fastening member configured to attach the TPA device to the electrical connector housing. The fastening member may include a latching hook configured to engage a receptacle of the electrical connector housing. In some embodiments, the locking body includes a closing member configured to secure the hinge member in the closed state by engagement with the electrical connector housing.

In some embodiments, the hinge member is a living hinge, and the assembly body, the locking body, and the hinge member are integrally formed from the same material. In some embodiments, the at least one locking member is configured to correspond to the terminal receiving cavity such that, in the closed state, the locking member fills a free space within the cavity by at least 70%. In some embodiments, the TPA device further includes a breakable support member configured to hold the hinge member in the open state prior to use.

Also disclosed is a kit including an electrical connector having an electrical connector housing with at least one terminal receiving cavity and a separate TPA device as described herein. Further disclosed is an assembly including an electrical connector and at least one TPA device attached to the electrical connector housing.

### BRIEF DESCRIPTION OF THE DRAWINGS

Other features, details, and advantages of the disclosure will become more apparent from the detailed illustrative description given hereafter with respect to the drawings in which:

FIG. 1A shows an isometric view of a TPA device attached to an electrical connector housing according to the prior art.

FIG. 1B shows a top view of a locking body of the TPA device of FIG. 1A according to the prior art.

FIG. 2 shows a side view of another electrical connector housing with an integrated TPA device according to the prior art.

FIG. 3A shows an isometric view of a TPA device with a locking blade according to some embodiments.

FIG. 3B shows an isometric view of a TPA device with locking teeth according to some embodiments.

FIG. 4 shows an isometric view of the TPA device of FIGS. 3A or 3B attached to an electrical connector housing according to some embodiments.

FIGS. 5A and 5B shows alternate side views of FIG. 4 with two TPA devices attached to the housing according to some embodiments.

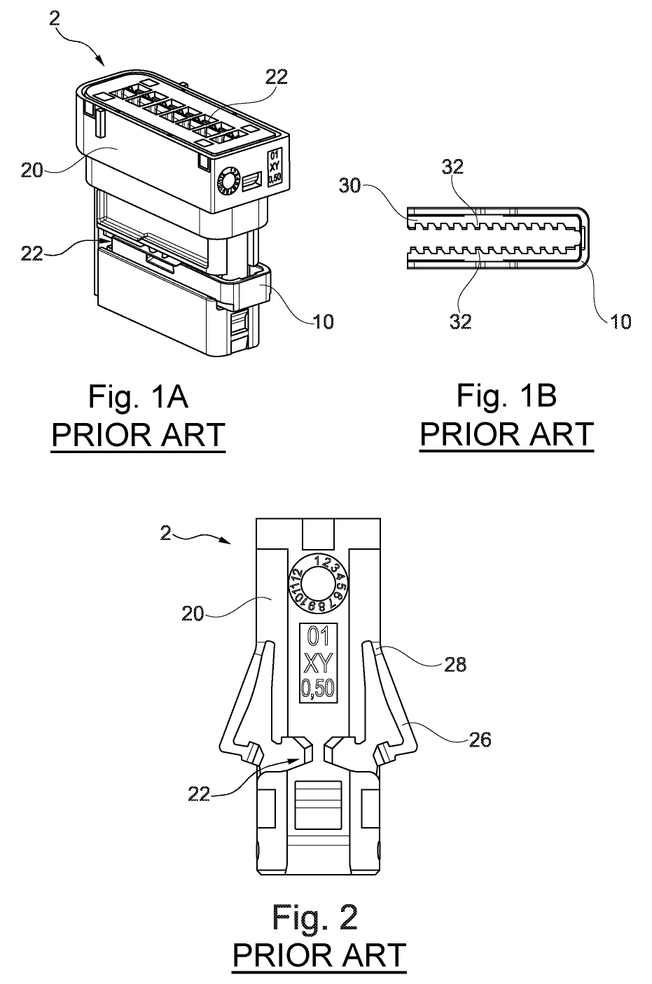

### DETAILED DESCRIPTION

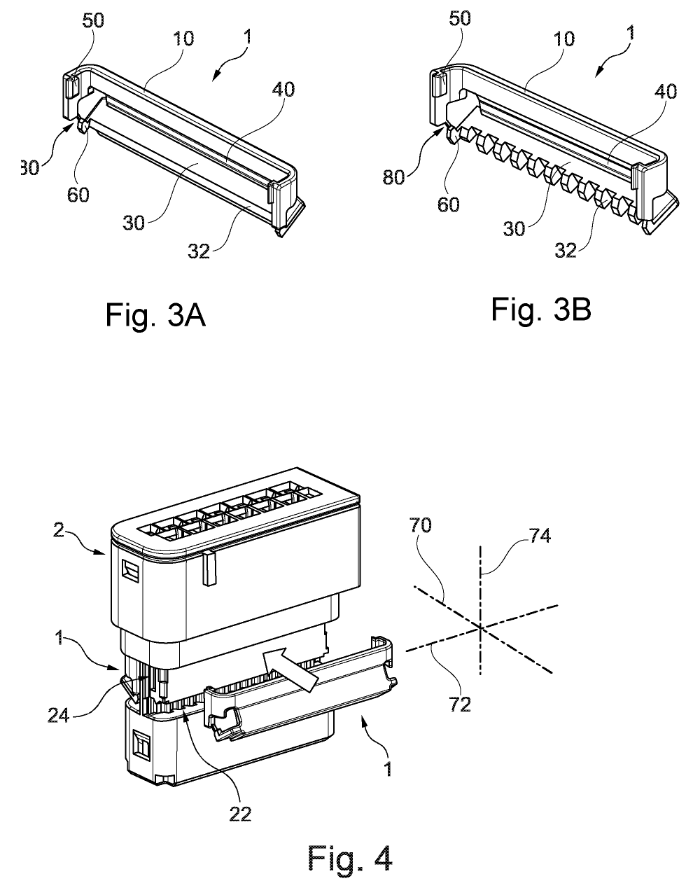

FIG. 3 illustrates two embodiments of a terminal position assurance (TPA) device 1 designed to be attached to an electrical connector 2. The assembly body 10 forms the main structural element and provides the framework to which other components are attached. This assembly body 10 is configured to be affixed to an electrical connector housing 20, thereby ensuring stability and proper alignment of the device.

Attached to, and in the illustrated embodiments integrally formed with, the assembly body 10 is the locking body 30, which features multiple locking members 32. These locking members 32 are designed to correspond with terminal receiving cavities 22 within the electrical connector housing 20, thereby ensuring secure engagement with terminals when the device is in the closed state. FIG. 3A shows one locking member in the form of a locking blade, whereas FIG. 3B shows multiple locking members 32 in the form of locking teeth.

The hinge member 40 connects the locking body 30 to the assembly body 10 and facilitates movement between an open and closed state. In the open state, the locking members 32 are not engaged with the terminals, which allows terminals to be inserted or removed from the connector housing. Conversely, in the closed state, the hinge member 40 positions the locking body 30 such that the locking members 32 engage the terminals, thus securing them within the terminal receiving cavities.

The fastening member 50 is depicted as a latching hook configured to engage a receptacle 24 on the electrical connector housing 20. This engagement ensures that the assembly body 10 is securely attached to the connector housing which prevents accidental detachment or misalignment during operation.

Additionally, the closing member 60 is shown as part of the locking body 30. This component is designed to secure the hinge member 40 in the closed position by engaging with the electrical connector housing 20. This engagement prevents the hinge member 40 from inadvertently moving to the open position, thus maintaining the secure engagement of the terminals.

A breakable support member 80 is also illustrated, connecting the locking body 30 to the assembly body 10. This breakable support member 80 holds the hinge member 40 in the first position, facilitating initial assembly and handling of the device. Once the device is ready for operation, the breakable support member 80 can be broken to allow movement of the hinge member to the closed position.

FIG. 4 shows an electrical connector 2 equipped with two TPA devices 1, of which one (on the left) is already mounted to the housing and the other one on the right-hand side is not yet mounted. The assembly body 10 of the TPA device 1 is configured to be secured to the electrical connector housing 20, and the locking body 30 features at least one locking member 32 (see FIG. 3) that corresponds to openings in the housing 20 that allow access to the terminal receiving cavity 22 within the housing 20.

The assembly body 10 is attached to the electrical connector housing 20 by first clipping on the assembly body 10 along a connecting axis 70 and then sliding it down along the mating axis 74. The hinge axis 72 of the hinge member 40 is arranged in a plane perpendicular to the mating axis 74, allowing the hinge member 40 to pivot between the open and closed states. The mating axis 74 is the axis along which the connector 2 is moved for mating with a corresponding counter connector (not shown).

In both FIGS. 3 and 4, the hinge member 40 is depicted as a living hinge, otherwise known as a film hinge, indicating that the assembly body 10, the locking body 30, and the hinge member 40 are integrally made from the same material, preferably injection molded plastic.

The locking member 32 is designed to correspond to the terminal receiving cavity 22 such that, in the closed state, the locking member 32 fills the free space in the cavity 22, i.e., space not occupied by the terminals or other components, by at least 70%, preferably 80%, and more preferably 90%. This ensures a secure engagement with the terminal within the cavity 22 and may increase signal integrity.

The assembly body 10, the locking body 30, and the breakable support member 80 shown in the preferred embodiments are injection molded in one piece, providing a seamless and integrated construction for the TPA device 1.

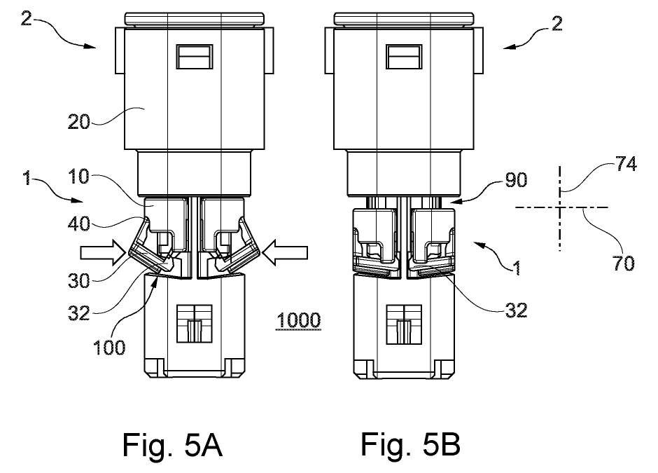

FIGS. 5A and 5B shows the embodiment of FIG. 4 in a side view, with the TPA devices 1 attached to the electrical connector 2. Together, the electrical connector 2 and the TPA devices 1 form an assembly 1000.

The assembly body 10 of each TPA device 1 is attached to the electrical connector housing 20 by first clipping the assembly body 10 on the housing along the connecting axis 70. In this state, the locking body 30 of each TPA device 1 impedes movement of the TPA device 1 along the mating axis 74 by contacting a contact point 100 on the electrical connector housing 20. Thereby, a movement along the mating axis 74 is prevented.

The hinge member 40 is arranged with a hinge axis 72 that is perpendicular to the mating axis 74 and the connecting axis 70. This perpendicular arrangement allows for the pivoting action of the hinge member 40, facilitating the transition between the open and closed states.

FIG. 5A further illustrates the TPA devices 1 in the open state and FIG. 5B shows the TPA devices 1 in the closed state, showing how the locking members 32 engage with the terminal receiving cavities 22 in the closed state. The hinge member 40 is shown pivoting around the hinge axis 72, which facilitates the transition between states. When moved into the closed state, each TPA device 1 slides down along the mating axis 74, which results in a free space 90. In other words, the TPA device 1 is closed along the axis 70 to its final position, whereby the locking body 30 comes into contact with the contact surface on which contact point 100 is situated to impede further movement along the axis 74.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A terminal position assurance (TPA) device for an electrical connector, the TPA device comprising:
an assembly body configured to be attached to an electrical connector housing; and
a locking body having at least one locking member extending from the locking body and corresponding to a terminal receiving cavity within the electrical connector housing, wherein the locking body is connected to the assembly body by means of a hinge member, wherein a first position of the hinge member defines an open state of the TPA device in which the locking member is not operable to engage a terminal within the terminal receiving cavity, and wherein a second position of the hinge member defines a closed state of the TPA device in which the locking member is operable to engage a terminal within the terminal receiving cavity.

2. The TPA device of claim 1, wherein the locking body comprises a plurality of locking members.

3. The TPA device of claim 2, wherein the locking members are locking teeth.

4. The TPA device of claim 1, wherein the locking member is a locking blade.

5. The TPA device of claim 1, wherein the assembly body comprises a fastening member configured for attaching the assembly body to an electrical connector housing.

6. The TPA device of claim 5, wherein the fastening member is a latching hook configured to engage with a receptacle on the electrical connector housing.

7. The TPA device of claim 1, wherein the locking body comprises a closing member configured to secure the hinge member in the second position by engaging with the electrical connector housing.

8. The TPA device of claim 7, further comprising a breakable support member connecting the locking body to the assembly body so that the hinge member is held in the first position.

9. The TPA device of claim 8, wherein the breakable support member connects the closing member to the assembly body.

10. The TPA device of claim 1, wherein the assembly body is configured to be attached to the electrical connector housing via a mating axis, and wherein a hinge axis of the hinge member is arranged in a plane perpendicular to the mating axis.

11. The TPA device of claim 1, wherein the hinge member is a living hinge, so that the assembly body, the locking body, and the hinge member are all made from the same material.

12. The TPA device of claim 11, wherein the assembly body, the locking body, and the hinge member are all made from a plastic material.

13. The TPA device of claim 1, wherein the at least one locking member corresponds to the terminal receiving cavity so that in the second position of the hinge member the locking member fills a free space not occupied by a terminal by at least 70%.

14. The TPA device of claim 8, wherein the assembly body, the locking body, and the breakable support member are molded in one piece.

15. A kit comprising:
an electrical connector having an electrical connector housing with at least one terminal receiving cavity; and
the TPA device of claim 1.

16. An assembly comprising:
an electrical connector having an electrical connector housing with at least one terminal receiving cavity; and
the TPA device of claim 1, wherein the TPA device is attached to the electrical connector housing.

17. The assembly of claim 16, wherein the hinge member of each TPA device is in the first position, and the locking body of each TPA device is configured to impede movement of the TPA device along a mating axis by contacting a contact point on the electrical connector housing.
